(19) United States
(12) Patent Application Publication
(10) Pub. No.: US 2008/0065588 A1
(43) Pub. Date: Mar. 13, 2008

(54) Selectively Logging Query Data Based On Cost

(76) Inventors: Craig Stephen Aldrich, Rochester, MN (US); Mark John Anderson, Oronoco, MN (US); Robert Joseph Bestgen, Rochester, MN (US); Randy L. Egan, Rochester, MN (US); Thomas James Schreiber, Rochester, MN (US); Mark D. Taylor, Rochester, MN (US); Bruce Hubbard Vining, Rochester, MN (US)

Correspondence Address: Steven W. Roth;IBM Corporation, Dept. 917, 3605 Highway 52 North, Rochester, MN, 55901-7829, US

(21) Appl. No.: 11/467,024

(22) Filed: Aug. 24, 2006

(51) Int. Cl. G06F 17/30

(52) U.S. Cl. 707/2

(57) ABSTRACT

If the cost of an access plan meets a condition, and an exit program is registered, data is logged for the access plan if logging is requested by a return code from the exit program. Execution of the access plan is continued or canceled if requested by the return code. In another embodiment, an inquiry message is sent to an application, the data is logged and execution of the access plan is continued or canceled if requested by a response to the inquiry message. In another embodiment, the data is logged if the logging if an override parameter requests the logging. In various embodiments, the cost of the access plan is calculated by predicting a predicted time for the execution and a predicted amount of storage needed for the execution or by calculating the actual time and the actual amount of storage used by partial execution of the access plan.

### FIELD

An embodiment of the invention relate to computer systems with databases. More specifically, an embodiment relates to selectively logging query data based on the cost of an access plan and programmatic response to a query governor.

### BACKGROUND

Fundamentally, computer systems are used for the storage, manipulation, and analysis of data. One mechanism for managing data is called a database management system, which may also be called a database system or simply a database. The database is typically stored for use on disk drives or other mass storage device. The most common form of database is usually called a relational database, which organizes data in tables that have rows, which represent individual entries, tuples, or records in the database, and columns, fields, or attributes, which define what is stored in each row, entry, or record. Each table has a unique name within the database and each column has a unique name within the particular table. The database also has an index, which is a data structure that informs the database management system of the location of a certain row in a table given an indexed column value, analogous to a book index informing the reader on which page a given word appears.

A database management system is structured to accept commands to store, retrieve and delete data using, for example, high-level query languages such as the Structured Query Language (SQL). The term “query” denominates a set of commands for retrieving data from a stored database. These queries may come from users, application programs, or remote systems (clients or peers). The query language requires the return of a particular data set in response to a particular query, but the method of query execution employed by the database management system is not specified by the query. The method of query execution is typically called an execution plan, an access plan, or just “plan.” Often, many different access plans for any particular query may be created, each of which returns the required data set. For large databases, the access plan selected by the database management system to execute a query must provide the required data at a reasonable cost in time and hardware resources. In general, the overall optimization process includes four broad stages. These are (1) casting the user query into some internal representation, (2) converting the internal representation to canonical form, (3) choosing prospective implementation procedures, and (4) generating executable plans and choosing the best performing (in terms of response time or storage use) of the plans.

To successfully implement an application that invokes queries, database management systems typically provide a process to track or capture the database activity that is taking place within the system. Such processes are known in the art as “monitors.” Monitors can include, but are not limited to, the execution of queries against the database. All of the information captured from these monitors can be stored in either a log file or in another storage medium that will allow for easy access to the data to perform any analysis. The results of these monitors can be analyzed to determine if the system is operating in an optimal manner. Queries that are not making the best use of the system resources can be identified for further analysis or tuning.

Monitors can capture their information in many ways. For example, the monitor may capture the information while the query is active (called runtime monitoring) or may perform its capture from a separate process and extract the information about a query from its access plan. Both of these methods require that the system expend resources capturing and formulating the information into a form that can be easily extracted and stored. On a system with a large database with frequent database access, these resources can potentially degrade the overall performance of the system and the large volume of information collected can make analysis difficult and time consuming. Hence, a primary problem associated with the use of monitors is the need to balance the amount of information collected against the resources required to formulate the data into a usable form suitable for analysis.

Various techniques have been tried to lessen the impact that monitors have on overall system throughput and to reduce the amount of information captured. For example, the level of detail of stored information can be adjusted to control the amount of resources that are expended to formulate and store the records that describe the individual query. As another example, duplicate records for identical queries may be detected, in order to prevent information about each occurrence of the query from being added to the log file. Further, the storage medium or system itself can be manipulated to optimize access to the log file to take advantage of any inherit strengths of the I/O (Input/Output) system to speed writes into the log file. But, these techniques lack the flexibility to adapt to the changing needs of the user who needs to analyze the logged information and do not effectively find the correct query for which to log the information.

Thus, an enhanced technique is needed that is configured to reduce the overhead associated with maintaining log information for queries in a database environment.

### SUMMARY

A method, apparatus, system, and signal-bearing medium are provided. In an embodiment, if the cost of an access plan for a query meets a condition, and an exit program is registered for the condition, the exit program is invoked, and data is logged for the access plan if logging is requested by a return code from the exit program. Execution of the access plan is continued or canceled if requested by the return code. In an embodiment, multiple exit programs are invoked, and the return code with the highest priority is used. In another embodiment, an inquiry message is sent to an application that requested the query if the inquiry message is requested by the return code, the data is logged if logging is requested by a response to the inquiry message, and execution of the access plan is continued or canceled if requested by the response. In another embodiment, the data is logged even if the logging is not requested by the response or the return code, but an override parameter requests the logging. In various embodiments, the cost of the access plan is calculated by predicting a predicted time for the execution and a predicted amount of storage needed for the execution or by calculating the actual time and the actual amount of storage used by partial execution of the access plan.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2A depicts a block diagram for an example data structure for a log, according to an embodiment of the invention.

FIG. 2B depicts a block diagram for an example data structure for return code data, according to an embodiment of the invention.

FIG. 3 depicts a flowchart of example processing for a query, according to an embodiment of the invention.

FIG. 4 depicts a flowchart of example processing for a query governor and monitor, according to an embodiment of the invention.

FIG. 5 depicts a flowchart of example processing for handling a return code from an exit program, according to an embodiment of the invention.

FIG. 6 depicts a flowchart of example processing for sending an inquiry message and processing a response, according to an embodiment of the invention.

FIG. 7 depicts a flowchart of example processing for handling responses from the inquiry message, according to an embodiment of the invention.

FIG. 8 depicts a flowchart of further example processing for executing an access plan, according to an embodiment of the invention.

FIG. 9 depicts a flowchart of example processing for invoking exit programs, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

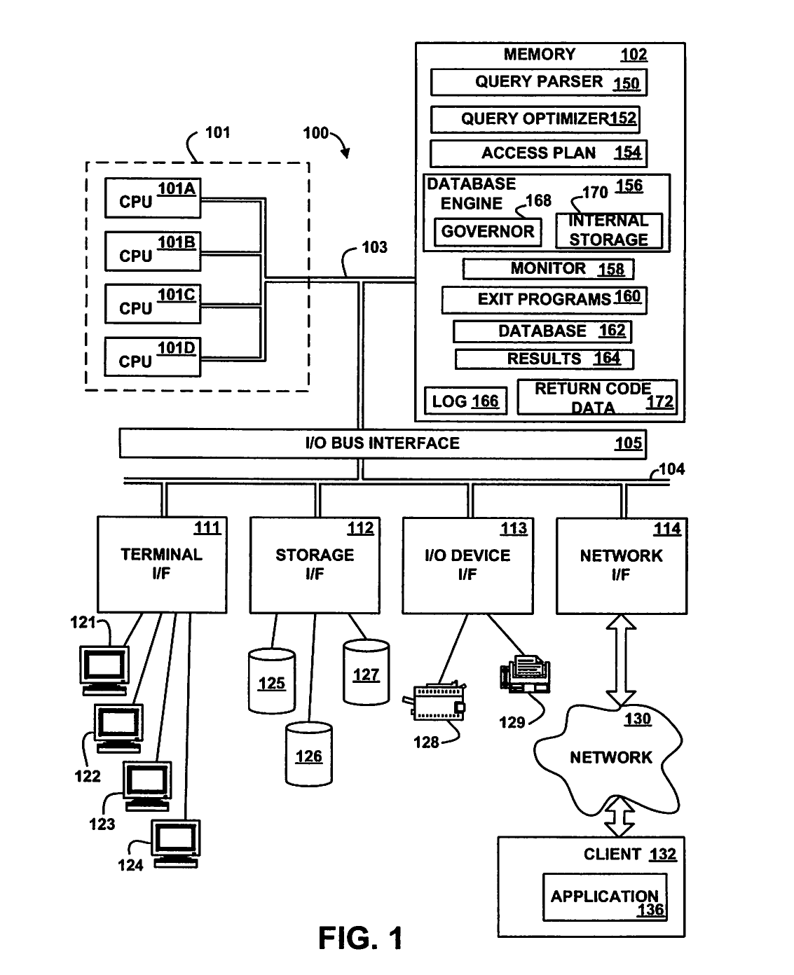

Referring to the Drawings, wherein like numbers denote like parts throughout the several views, FIG. 1 depicts a high-level block diagram representation of a server computer system 100 connected to a client computer system 132 via a network 130, according to an embodiment of the present invention. The terms “client” and “server” are used herein for convenience only, and in various embodiments a computer that operates as a client in one environment may operate as a server in another environment, and vice versa. In an embodiment, the hardware components of the computer system 100 may be implemented by a System i5 computer system available from International Business Machines of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 includes a query parser 150, a query optimizer 152, an access plan 154, a database engine 156, a monitor 158, exit programs 160, a database 162, results 164, a log 166, and return code data 172. Although the query parser 150, the query optimizer 152, the access plan 154, the database engine 156, the monitor 158, the exit programs 160, the database 162, the results 164, the log 166, and the return code data 172 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the query parser 150, the query optimizer 152, the access plan 154, the database engine 156, the monitor 158, the exit programs 160, the database 162, the results 164, the log 166, and the return code data 172 are illustrated as being contained within the main memory 102, they are not necessarily all completely contained in the same storage device at the same time. Further, although the query parser 150, the query optimizer 152, the access plan 154, the database engine 156, the monitor 158, the exit programs 160, the database 162, the results 164, the log 166, and the return code data 172 are illustrated as being separate entities, in other embodiments some of them, or all of them, may be packaged together.

The query parser 150 responds to submission of a query from the client computer system 132 by providing the query optimizer 152 with parsed code that permits selecting from multiple access plans 154. The query optimizer 152 selects the manner in which queries will be processed by the database engine 156 against the database 162. The primary task of the query optimizer 152 is to determine the most efficient, least expensive, or least costly way to execute each particular query request against the database 162. To this end, the query optimizer 152 chooses one access plan from a group of possible access plans 154. The costs of a particular access plan 154 may be estimated resource requirements determined in terms of time and space. More specifically, the resource requirements may include system information such as the location of database tables and parts of tables, the size of such tables, network node locations, system operating characteristics and statistics, estimated runtime for a query, space usage, and other appropriate information. The access plan 154 contains low-level information indicating what steps the database engine 156 is to take to execute the query.

Once the query optimizer 152 has selected an access plan 154, the query optimizer 152 sends the access plan 154 to the database engine 156, which executes the access plan 154 against the database 162, to create the results 164. The results 164 may include one or more output data tables of records from the database 162, according to the specification included in a query received from the client computer system 132. The terminals 121, 122, 123, or 124 may displays the results 164 to the user, or the results 164 may be sent to the client 132 or to any appropriate computer attached to the network 130.

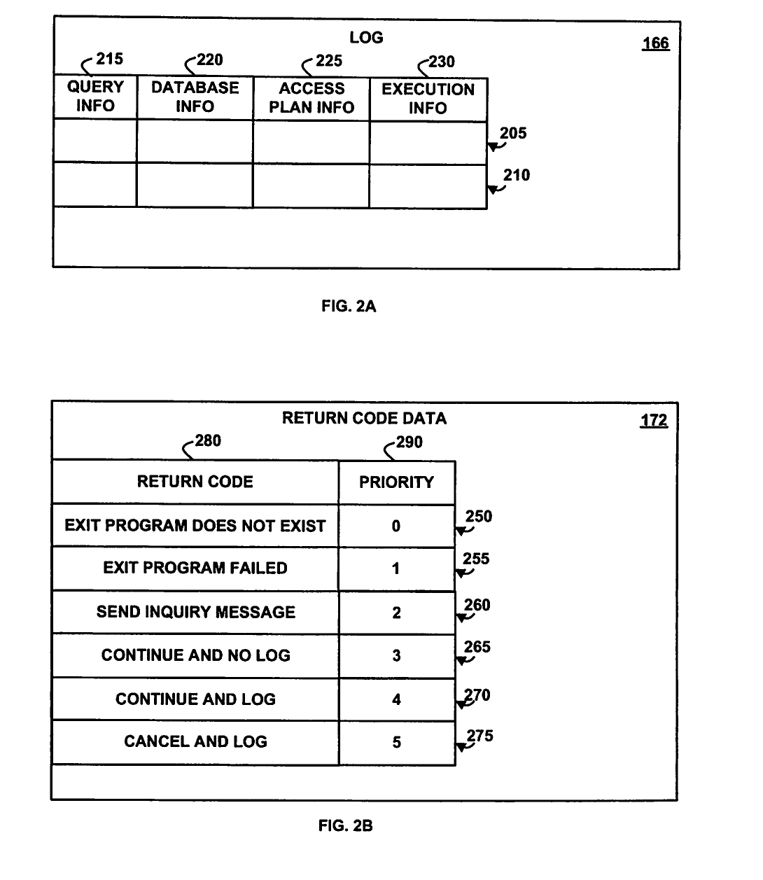

The database engine 156 includes a query governor 168 and internal storage 170. The query governor 168 determines when to instruct the monitor 158 to collect information. The monitor 158, if executed for a particular query, collects information related to the query and writes the collected information to the log 166. The log 166 may be a base table or some allocated portion of the main memory 102. The log 166 may later be accessed to retrieve query implementation information for purposes of, for example, determining system efficiency or diagnosing problems. The log 166 is further described below with reference to FIG. 2A. The database engine 156 uses the internal storage 170 for temporary copies of data, for sorting data, for hashing functions, and for optimizing the implementation of the query.

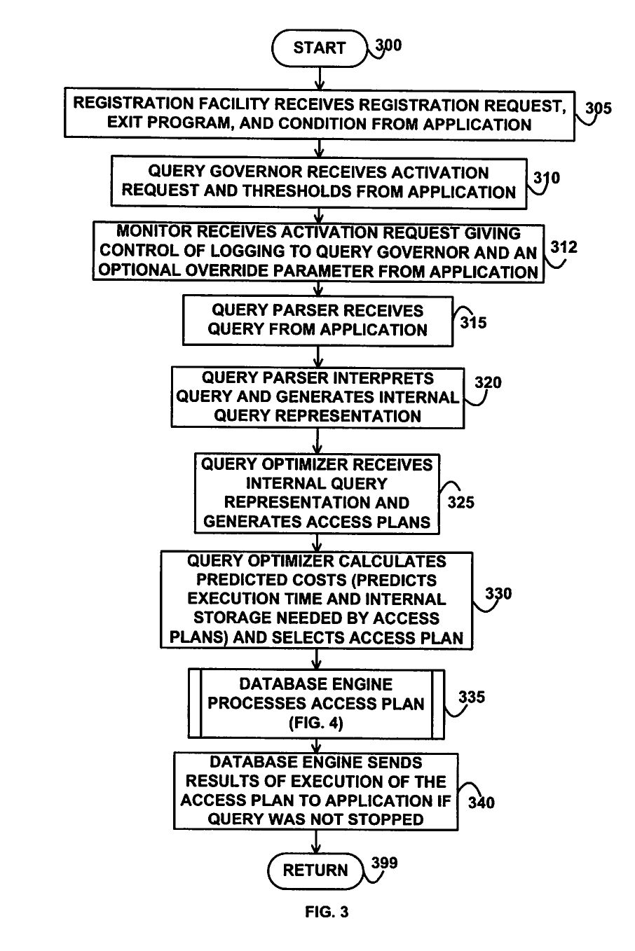

In an embodiment, the query governor 168 includes instructions capable of executing on the processor 101 or statements capable of being interpreted by instructions executing on the processor 101 to perform the functions as further described below with reference to FIGS. 3, 4, 5, 6, 7, 8, and 9. In another embodiment, the query governor 168 may be implemented in microcode. In another embodiment, the query governor 168 may be implemented in hardware via logic gates and/or other appropriate hardware techniques.

The exit programs 160 may be provided by the client computer system 132, a user, or a third party. The exit programs 160 receive information regarding a query from the query governor 168 and return a return code to the query governor 168. The query governor 168 uses the return codes from the exit programs 160 to decide whether to continue execution of the query, cancel execution of the query, write information regarding the query to the log 166, and/or refrain from writing information regarding the query to the log 166. The query governor 168 may invoke multiple exit programs 160 and select between their return codes based on priorities of the return codes. Example return codes and their priorities are further described below with reference to FIG. 2B.

The database 162 is a repository for data. In an embodiment, the database 162 is a relational database composed of tables of rows (records) and columns (fields) and an index used to access the tables.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

The client computer system 132 may include some or all of the hardware and/or software elements previously described above for the computer system 100. The client computer system 132 includes an application 136, which sends queries to the query parser 150. Although the client computer system 132 is illustrated as being separate from and connected to the computer system 100 via the network 130, in another embodiment, the application 136 may be implemented as a software program and data stored in the memory 102 of the computer system 100.

It should be understood that FIG. 1 is intended to depict the representative major components of the computer system 100, the network 130, and the client computer system 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of tangible signal-bearing media that may be operatively or communicatively connected (directly or indirectly) to the processor 101. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), CD-RW, or diskette; or

(3) information conveyed to the computer system 100 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2A depicts a block diagram for an example data structure for the log 166, according to an embodiment of the invention. The log 166 includes any number of records, such as the records 205 and 210. Each of the records characterizes planned or actual usage of resources of the computer system 100 needed or used to execute a query. For example, each of the records 205 and 210 includes a query information field 215, a database information field 220, an access plan information field 225, and an execution information field 230, but in other embodiments more or fewer fields may be present. The query information field 215 describes the query that was received from the application 136 for which the record in the log 166 is created. The query information 215 may further identify the application 136, the client computer system 132, or user that requested the query. The query information 215 may further include keys and/or key values that identify that the query requests to be retrieved from the database 162. The query information 215 may further include any conditions that the data retrieved from the database 162 must satisfy. The database information field 220 identifies the database 162 to which the query is directed, and my further include identifications of data tables and indexes used to process the query. The access plan information field 225 includes some or all of the information of the access plan 154. The execution information field 230 describes the database I/O activity that is planned or was undertaken to implement the query represented by the query information 215.

FIG. 2B depicts a block diagram for an example data structure for the return code data 172, according to an embodiment of the invention. The return code data 172 includes any number of records, such as the records 250, 255, 260, 265, 270, and 275, each of which includes a return code field 280 and a priority field 290. The return code field 280 includes all possible return codes that may be returned by the exit programs 160. The priority field 290 indicates the priority, importance, or order of precedence of each return code relative to the other return codes 280. Although the values in the priority field 290 are illustrated with the highest number having the highest priority, in other embodiments, the lowest numerical value may have the highest priority, or any other appropriate technique may be used for indicating priority.

FIG. 3 depicts a flowchart of example processing for a query, according to an embodiment of the invention. Control begins at block 300. Control then continues to block 305 where a registration facility receives a registration request, an identification of the exit program 160, and a condition from the application 136. The registration requests that the query governor 168 invoke the identified exit program 160 in response to the occurrence of the specified condition (in response to the condition being evaluated to true). Examples of conditions include a predicted query runtime being greater than a predicted runtime threshold, a predicted amount of internal storage being greater than a predicted storage threshold, an actual query runtime being greater than an actual runtime threshold, and an actual internal storage amount used by execution of an access plan 154 being greater than an actual storage threshold. The registration request may further include an execution criteria, which specifies the environment that must be met in order to invoke a particular exit program 160. Examples of execution criteria include a specified job in which the condition must have occurred; a time, date, or day of the week at which the condition must have occurred; a specified application or user that submitted the query that was being executed when the condition occurred, or any other appropriate execution criteria. The execution criteria allow a variety of exit programs to be used for the same condition, depending on the environment that exists when the condition occurs.

Control then continues to block 310 where the query governor 168 receives an activation request and thresholds (e.g., the values for the predicted runtime threshold, the predicted storage threshold, the actual runtime threshold, and the actual storage threshold) from the application 136.

Control then continues to block 312 where the monitor 158 receives an activation request that requests giving control of logging to the query governor 168 and an optional override parameter from the application 136. In various embodiments, the override parameter is scoped to, applies to, or affects all queries directed to a specified database 162, all queries that execute in a specified job, or all queries executed in the computer system 100.

Control then continues to block 315 where the query parser 150 receives a query from the application 136 that is directed to the database 162. In an embodiment, the query may be in the format of an SQL (Structured Query Language) statement, but in other embodiments, any appropriate format may be used.

Control then continues to block 320 where the query parser 150 interprets or compiles the query to generate an internal query representation of the query. Control then continues to block 325 where the query optimizer 152 receives the internal query representation and generates one or more access plans 154. The access plans 154 represent the computer-generated sequence of operations to obtain the data specified by the query from the database 162.

Control then continues to block 330 where the query optimizer 152 calculates predicted costs for the various access plans 154 and selects the access plan 154 with the lowest cost. The costs are predicted in the sense that the calculation occurs prior to the execution of the access plan 154. In various embodiments, the predicted cost includes a predicted time (predicted runtime) for the execution of the access plan 154 and a predicted amount of the internal storage 170 needed to execute the access plan 154. Generation of the predicted cost involves consideration of both the available access paths (e.g., indexes and sequential reads) and system held statistics on the data to be accessed (e.g., the size of a database table and the number of distinct values in a particular column), to choose what the query optimizer 152 considers to be the most efficient access plan 154 for the query. In an embodiment, the query optimizer 152 may compare the costs of the access plans 154 until either no alternatives remain or a time limit expires. Selection of a plan may be performed by the query optimizer 152 according to a predetermined cost formula. The selection of the most efficient access plan 154 utilizes the query, the database 162 to which the query is directed, and system information that is available to the query optimizer 152. Such system information may include any variety of cost factors such as access paths, system held statistics, estimated runtime, system resources, and system usage.

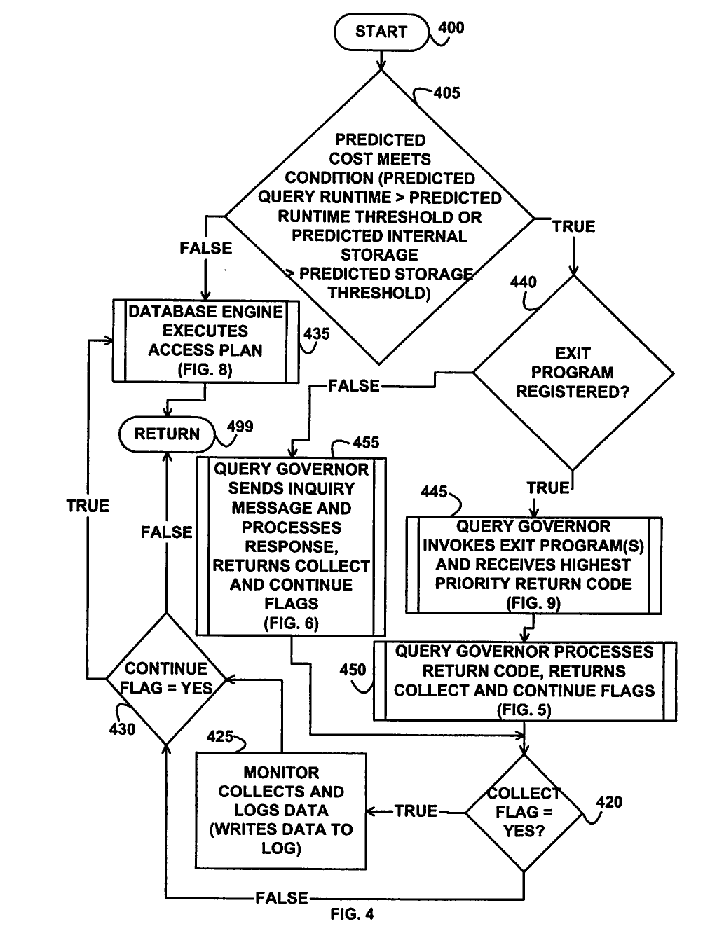

Control then continues to block 330 where the database engine 156 processes the access plan 154, as further described below with reference to FIG. 4. Control then continues to block 340 where the database engine 156 sends the results 164 of the execution of the access plan 154 to the application 136 if the execution of the access plan 154 for the query was not stopped. Control then continues to block 399 where the logic of FIG. 3 returns.

FIG. 4 depicts a flowchart of example processing for a query governor 168 and monitor 158, according to an embodiment of the invention. Control begins at block 400. Control then continues to block 405 where the query governor 168 determines whether the predicted cost of executing the access plan 154 meets a condition. For example, the query governor 168 determines whether the predicted query runtime (the predicted execution time of the access plan 154) is greater than the predicted runtime threshold or the predicted amount of the internal storage 170 that is needed to execute the access plan 154 is greater than the predicted storage threshold.

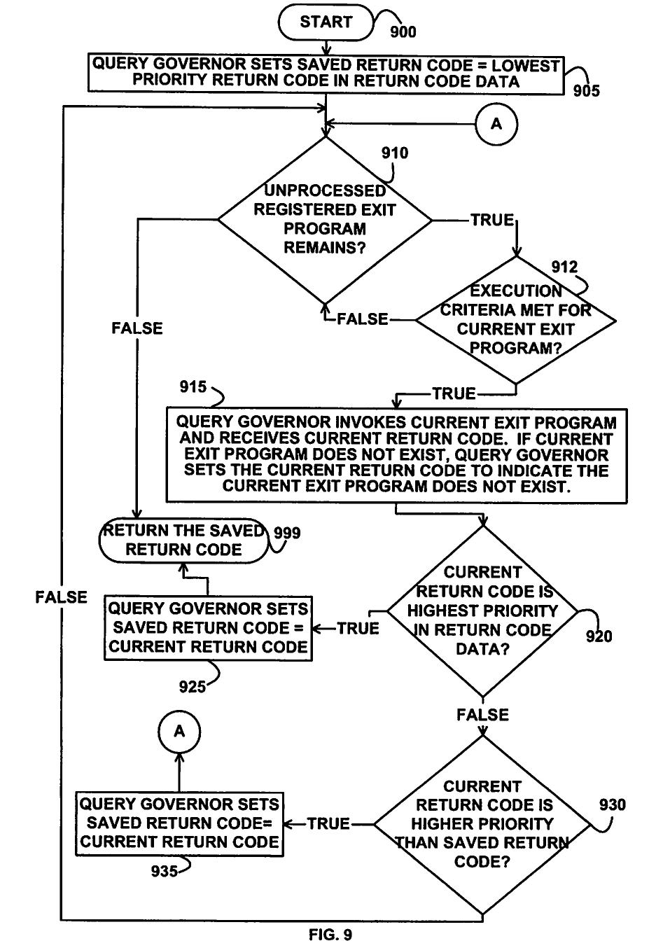

If the determination at block 405 is true, then the predicted cost to execute the access plan 154 meets a condition, so control continues to block 440 where the query governor 168 determines whether exit program(s) 160 are registered for the condition that was previously determined to have been met at block 405. Thus, the query governor 168 may select a particular exit program or exit programs that meet the condition. If the determination at block 440 is true, then an exit program 160 is registered for the met condition, so control continues to block 445 where the query governor 168 invokes the exit program(s) 160 and receives a return code, as further described below with reference to FIG. 9. If multiple exit programs 160 are invoked, the logic of FIG. 9 returns the return code that has the highest priority.

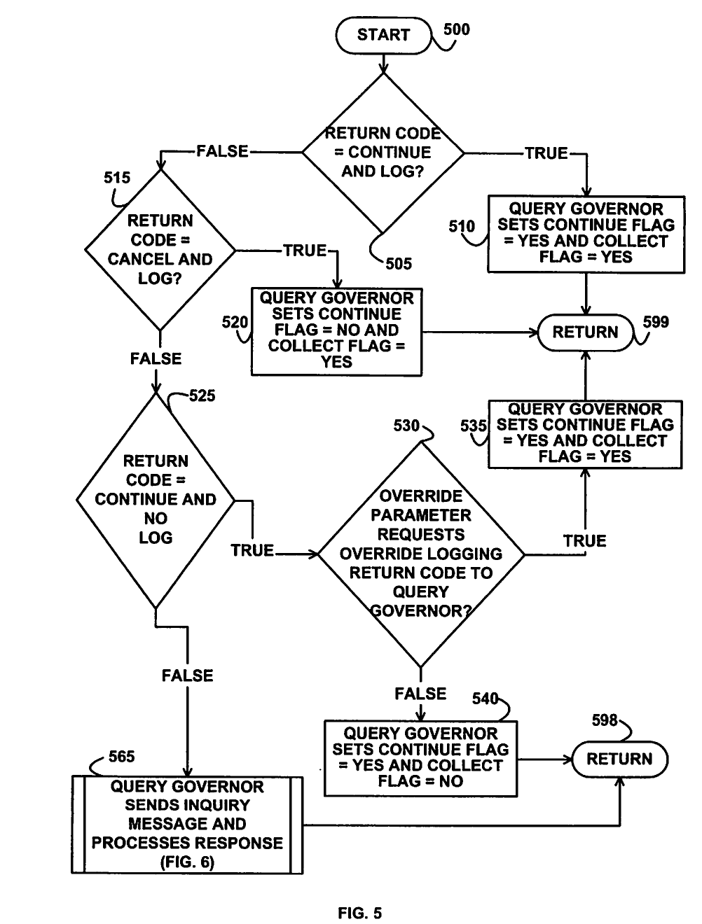

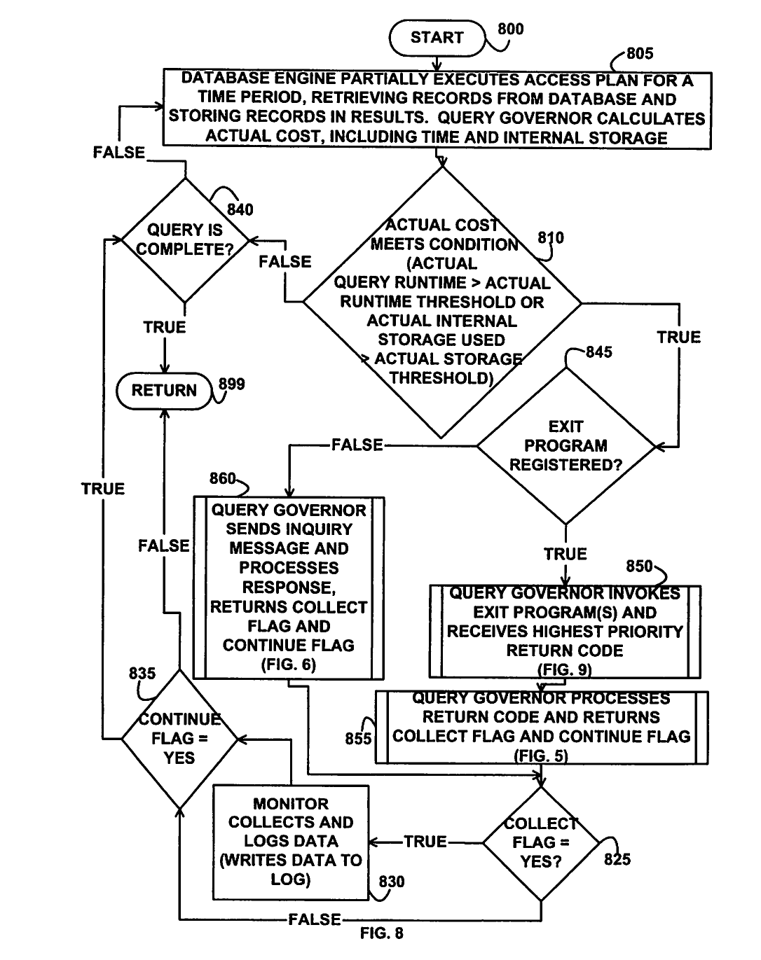

Control then continues to block 450 where the query governor 168 processes the return code, as further described below with reference to FIG. 5. The logic of FIG. 5 returns a collect flag and a continue flag. The collect flag controls whether data is collected and logged to the log 166, and the continue flag controls whether execution of the access plan 154 continues. Control then continues to block 420 where the query governor 168 determines whether the collect flag is set to yes, indicating that data is to be collected and logged. If the collect flag is set to yes, then data is to be collected and logged, so control continues to block 425 where the query governor 168 invokes the monitor 158, which collects data and writes the data to the log 166, including the query information 215, the database information 220, the access plan information 225, and the execution information 230. Control then continues to block 430 where the query governor 168 determines whether the continue flag is yes, indicating that execution of the access plan 154 is to continue. If the determination at block 430 is true, then execution of the access plan 154 is to continue, so control continues to block 435 where the database engine 156 executes the access plan 154, as further described below with reference to FIG. 8. Control then continues to block 499 where the logic of FIG. 4 returns.

If the determination at block 430 is false, then execution of the access plan 154 is to be canceled, so control continues to block 499 where the logic of FIG. 4 returns without executing the access plan 154. Thus, execution of the access plan 154 is canceled without being started.

If the determination at block 420 is false, then the collect flag is false and data is not to be collected and logged, so control continues to block 430, as previously described above.

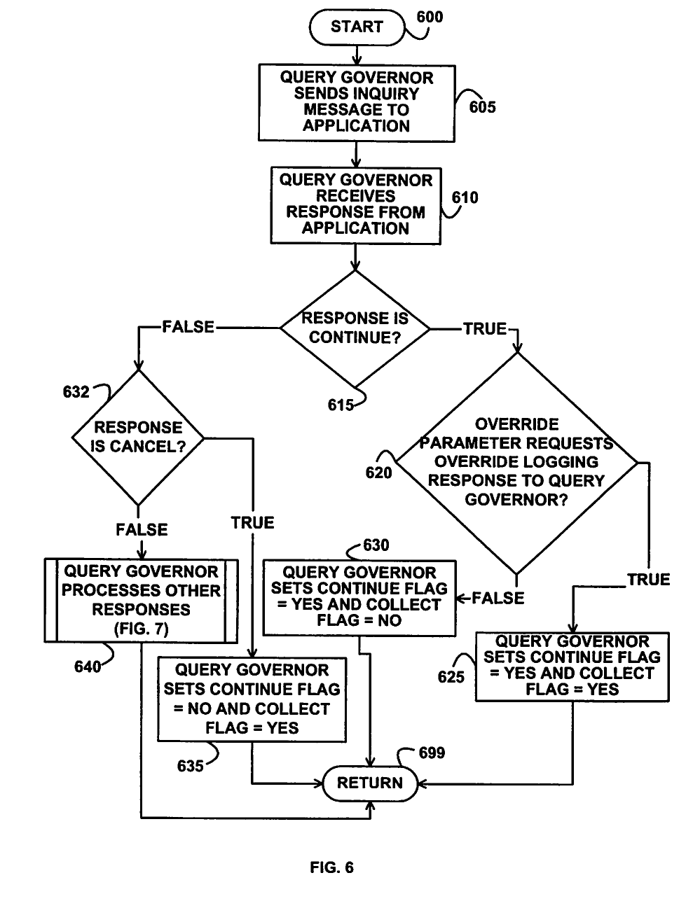

If the determination at block 440 is false, then an exit program 160 is not registered for the condition that was detected and met at block 405, so control continues from block 440 to block 455 where the query governor 168 sends an inquiry message and processes the response to the inquiry message, as further described below with reference to FIG. 6. The logic of FIG. 6 returns the collect flag and the continue flag. Control then continues to block 420, as previously described above.

If the determination at block 405 is false, then the predicted cost of executing the access plan does not meet the condition, so control continues to block 435 where the database engine 156 executes the access plan 154, as further described below with reference to FIG. 8. Control then continues to block 499 where the logic of FIG. 4 returns.

FIG. 5 depicts a flowchart of example processing for handling a return code from the exit program 160, according to an embodiment of the invention. Control begins at block 500. Control then continues to block 505 where the query governor 168 determines whether the return code from the exit program 160 requests continuing execution of the access plan 154 and collecting and logging data for the access plan 154. If the determination at block 505 is true, then the return code from the exit program 160 requests continuing execution of the access plan 154 and collecting and logging data for the access plan 154, so control continues to block 510 where the query governor 168 sets the continue flag to yes, which causes the query governor 168 to continue execution of the access plan 154 (see FIGS. 4 and 8). The query governor 168 further sets the collect flag to yes, which causes the monitor 158 to collect and log data (see FIGS. 4 and 8). Control then continues to block 599 where the logic of FIG. 5 returns.

If the determination at block 505 is false, then the return code is not continue and log, so control continues to block 515 where the query governor 168 determines whether the return code from the exit program 160 requests canceling execution of the access plan 154 and collecting and logging data for the access plan 154. If the determination at block 515 is true, then the return code from the exit program 160 requests canceling execution of the access plan 154 and collecting and logging data for the access plan 154, so control continues to block 520 where the query governor 168 sets the continue flag to no, which causes the query governor 168 to cancel execution of the access plan 154 (see FIGS. 4 and 8). The query governor 168 further sets the collect flag to yes, which causes the monitor 158 to collect and log data (see FIGS. 4 and 8). Control then continues to block 599 where the logic of FIG. 5 returns.

If the determination at block 515 is false, then the return code is not cancel and log, so control continues to block 525 where the query governor 168 determines whether the return code from the exit program 160 requests execution of the access plan 154 to continue and data to not be logged. If the determination at block 525 is true, then the return code from the exit program 160 requests execution of the access plan 154 to continue and data to not be logged, so control continues to block 530 where the query governor 168 determines whether the override parameter has been received that requests overriding the return code that was received from the exit program 160. If the determination at block 530 is true, then the override parameter has been received, so control continues to block 535 where the query governor 168 sets the continue flag to yes, which causes the query governor 168 to continue execution of the access plan 154 (see FIGS. 4 and 8). The query governor 168 further sets the collect flag to yes, which causes the monitor 158 to collect and log data (see FIGS. 4 and 8). Thus, if the override parameter requests the logging, the data is logged even if the logging is not requested by the return code from the exit program 160. Control then continues to block 599 where the logic of FIG. 5 returns.

If the determination at block 530 is false, then the override parameter was not received, so control continues to block 540 where the query governor 168 sets the continue flag to yes, which causes the query governor 168 to continue execution of the access plan 154 (see FIGS. 4 and 8). The query governor 168 further sets the collect flag to no, which prevents the monitor 158 from collecting and logging data (see FIGS. 4 and 8). Control then continues to block 598 where the logic of FIG. 5 returns.

If the determination at block 525 is false, then the return code from the exit program 160 requests the sending of an inquiry message or the exit program 160 failed, so control continues to block 565 where the query governor 168 sends an inquiry message and processes the response, as further described below with reference to FIG. 6. Control then continues to block 598 where the logic of FIG. 5 returns.

FIG. 6 depicts a flowchart of example processing for sending an inquiry message and processing a response, according to an embodiment of the invention. Control begins at block 600. Control then continues to block 605 where the query governor 168 sends an inquiry message to the application 136 that initiated the query. Control then continues to block 610 where the query governor 168 receives a response to the inquiry message from the application 136. Control then continues to block 615 where the query governor 168 determines whether the received response indicates a request to continue execution of the access plan 154.

If the determination at block 615 is true, then the response to the inquiry message is a request to continue execution of the access plan 154, so control continues to block 620 where the query governor 168 determines whether the override parameter has been received. If the determination at block 620 is true, then the override parameter has been received, so control continues to block 625 where the query governor 168 sets the continue flag to yes, which causes the query governor 168 to continue execution of the access plan 154 (see FIGS. 4 and 8). The query governor 168 further sets the collect flag to yes, which causes the monitor 158 to collect and log data (see FIGS. 4 and 8). Control then continues to block 699 where the logic of FIG. 6 returns. If the determination at block 620 is false, then the override parameter has not been received, so control continues to block 630 where the query governor 168 sets the continue flag to yes, which causes the query governor 168 to continue execution of the access plan 154 (see FIGS. 4 and 8). The query governor 168 further sets the collect flag to no, which prevents the monitor 158 from logging data (see FIGS. 4 and 8). Control then continues to block 699 where the logic of FIG. 6 returns.

If the determination at block 615 is false, then the response to the inquiry message is not a request to continue execution of the access plan 154, so control continues to block 632 where the query governor 168 determines whether the response to the inquiry message is a request to cancel execution of the access plan 154. If the determination at block 632 is true, then the response to the inquiry message is a request to cancel execution of the access plan 154, so control continues to block 635 where the query governor 168 sets the continue flag to no, which causes the query governor 168 to cancel execution of the access plan 154 (see FIGS. 4 and 8). The query governor 168 further sets the collect flag to yes, which causes the monitor 158 to collect and log data (see FIGS. 4 and 8). Control then continues to block 699 where the logic of FIG. 6 returns.

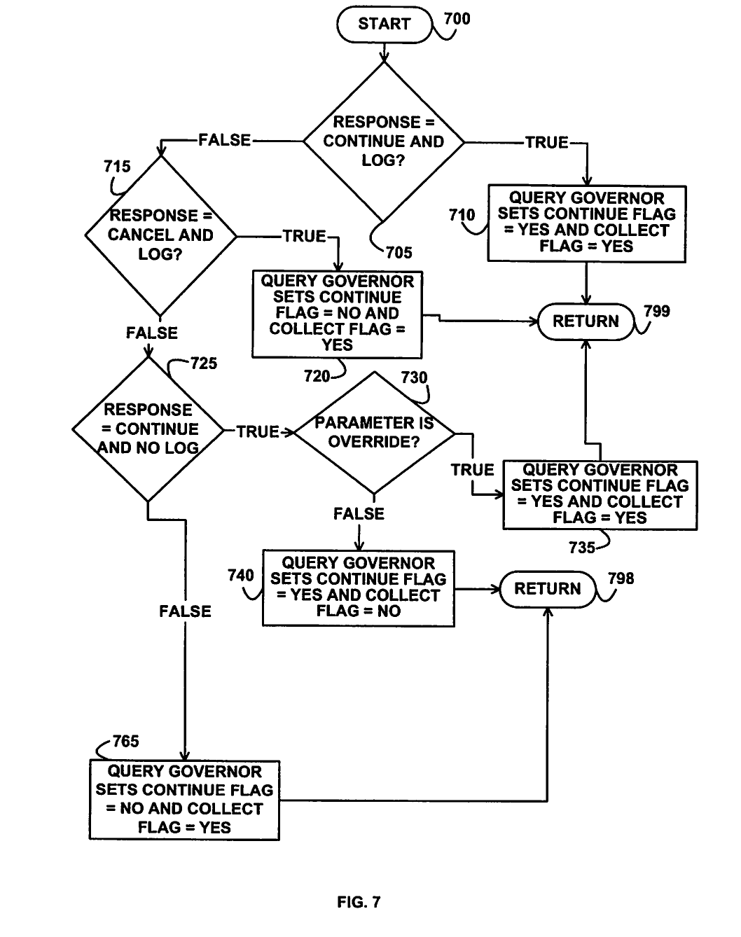

If the determination at block 632 is false, then the response to the inquiry message does not request canceling execution of the access plan 154, so control continues to block 640 where the query governor 168 processes other responses, as further described below with reference to FIG. 7. Control then continues to block 699 where the logic of FIG. 6 returns.

FIG. 7 depicts a flowchart of example processing for handling responses from the inquiry message, according to an embodiment of the invention. Control begins at block 700. Control then continues to block 705 where the query governor 168 determines whether the response to the inquiry message requests continuing execution of the access plan 154 and collecting and logging data for the access plan 154. If the determination at block 705 is true, then the response to the inquiry message requests continuing execution of the access plan 154 and collecting and logging data for the access plan 154, so control continues to block 710 where the query governor 168 sets the continue flag to yes, which causes the query governor 168 to continue execution of the access plan 154 (see FIGS. 4 and 8). The query governor 168 further sets the collect flag to yes, which causes the monitor 158 to collect and log data (see FIGS. 4 and 8). Control then continues to block 799 where the logic of FIG. 7 returns.

If the determination at block 705 is false, then the response to the inquiry message is not continue and log, so control continues to block 715 where the query governor 168 determines whether the response to the inquiry message requests canceling execution of the access plan 154 and collecting and logging data for the access plan 154. If the determination at block 715 is true, then the response to the inquiry message requests canceling execution of the access plan 154 and collecting and logging data for the access plan 154, so control continues to block 720 where the query governor 168 sets the continue flag to no, which causes the query governor 168 to cancel execution of the access plan 154 (see FIGS. 4 and 8). The query governor 168 further sets the collect flag to yes, which causes the monitor 158 to collect and log data (see FIGS. 4 and 8). Control then continues to block 799 where the logic of FIG. 7 returns.

If the determination at block 715 is false, then the response to the inquiry message is not cancel and log, so control continues to block 725 where the query governor 168 determines whether the response to the inquiry message requests execution of the access plan 154 to continue and data to not be logged. If the determination at block 725 is true, then the response to the inquiry message requests execution of the access plan 154 to continue and data to not be logged, so control continues to block 730 where the query governor 168 determines whether the override parameter has been received. If the determination at block 730 is true, then the override parameter has been received so control continues to block 735 where the query governor 168 sets the continue flag to yes, which causes the query governor 168 to continue execution of the access plan 154 (see FIGS. 4 and 8). The query governor 168 further sets the collect flag to yes, which causes the monitor 158 to collect and log data (see FIGS. 4 and 8). Thus, if the override parameter requests the logging, the data is logged even if the logging is not requested by the response to the inquiry message. Control then continues to block 799 where the logic of FIG. 7 returns.

If the determination at block 730 is false, then the override parameter was not received, so control continues to block 740 where the query governor 168 sets the continue flag to yes, which causes the query governor 168 to continue execution of the access plan 154 (see FIGS. 4 and 8). The query governor 168 further sets the collect flag to no, which prevents the monitor 158 from collecting and logging data (see FIGS. 4 and 8). Control then continues to block 798 where the logic of FIG. 7 returns.

If the determination at block 725 is false, then no response to the inquiry message was received, so control continues to block 765 where the query governor 168 sets the continue flag to no, which causes the query governor 168 to cancel execution of the access plan 154 (see FIGS. 4 and 8). The query governor 168 further sets the collect flag to yes, which causes the monitor 158 to collect and log data (see FIGS. 4 and 8). Control then continues to block 798 where the logic of FIG. 7 returns.

FIG. 8 depicts a flowchart of further example processing for executing an access plan 154, according to an embodiment of the invention. Control begins at block 800. Control then continues to block 805 where the database engine 156 partially executes the access plan 154 for a time period against the database 162, retrieving records from the database 162 using the access plan 154 and the internal storage 170 and storing the records in the results 164. The query governor 168 calculates the actual cost of the partial execution of the access plan 154 by calculating an actual time used by the partial execution of the access plan 154 and calculating an actual amount of the internal storage 170 used by the partial execution.

At the expiration of the time period, control then continues to block 810 where the query governor 168 determines whether the actual cost of partially executing the access plan 154 meets a condition. For example, the query governor 168 determines whether the actual query runtime (the actual execution time of the access plan 154) is greater than the actual runtime threshold or the actual amount of the internal storage 170 that is needed to execute the access plan 154 is greater than the actual storage threshold.

If the determination at block 810 is true, then the actual cost of the partial execution of the access plan 154 meets the condition, so control continues to block 845 where the query governor 168 determines whether exit program(s) 160 are registered for the condition that was previously determined to have been met at block 810. Thus, the query governor 168 may select a particular exit program or exit programs that meet the condition. If the determination at block 845 is true, then an exit program 160 is registered for the met condition, so control continues to block 850 where the query governor 168 invokes the registered exit program(s) 160 and receives a return code, as further described below with reference to FIG. 9. If multiple exit programs 160 are invoked, the logic of FIG. 9 returns the return code that has the highest priority.

Control then continues to block 855 where the query governor 168 processes the return code, as further described below with reference to FIG. 5. The logic of FIG. 5 returns a collect flag and a continue flag. The collect flag controls whether data is collected and logged to the log 166, and the continue flag controls whether execution of the access plan 154 continues. Control then continues to block 825 where the query governor 168 determines whether the collect flag is set to yes, indicating that data is to be collected and logged. If the collect flag is set to yes, then data is to be collected and logged, so control continues to block 830 where the query governor 168 invokes the monitor 158, which collects data and writes the data to the log 166, including the query information 215, the database information 220, the access plan information 225, and the execution information 230.

Control then continues to block 835 where the query governor 168 determines whether the continue flag is yes, indicating that execution of the access plan 154 is to continue. If the determination at block 835 is true, then execution of the access plan 154 is to continue, so control continues to block 840 where the query governor 168 determines whether execution of the query has been completed by the multiple partial executions of the access plan.

If the determination at block 840 is true, then execution of the query is complete, so control continues to block 899 where the logic of FIG. 8 returns.

If the determination at block 840 is false, then the execution of the query is not complete, so control returns to block 850 where the database engine 156 continues partially executing the query via the access plan, as previously described above.

If the determination at block 835 is false, then execution of the access plan 154 is to be canceled, so control continues to block 899 where the logic of FIG. 8 returns without continuing to execute the access plan 154. Thus, execution of the access plan 154 is canceled after partial execution.

If the determination at block 825 is false, then the collect flag is false and data is not to be collected and logged, so control continues to block 835, as previously described above.

If the determination at block 845 is false, then an exit program 160 is not registered for the condition that was detected and met at block 810, so control continues from block 845 to block 860 where the query governor 168 sends an inquiry message and processes the response to the inquiry message, as further described below with reference to FIG. 6. The logic of FIG. 6 returns the collect flag and the continue flag. Control then continues to block 825, as previously described above.

If the determination at block 810 is false, then the actual cost of the partial execution of the access plan 154 does not meet the condition, so control continues to block 840, as previously described above.

FIG. 9 depicts a flowchart of example processing for invoking the exit programs 160, according to an embodiment of the invention. Control begins at block 900. Control then continues to block 905 where the query governor 168 initializes a saved return code to be the return code in the return code data 172 that has the lowest priority 290 or is the least important, e.g., the return code 280 in the record 250. Control then continues to block 910 where the query governor 168 determines whether a registered exit program 160 remains that has not been processed by the loop that starts at block 910.

If the determination at block 910 is true, then a registered exit program 160 remains that has not been processed by the loop that starts at block 910, so control continues to block 912 where the query governor 168 determines whether the execution criteria for the current exit program 160 is met. Examples of execution criteria include a specified job in which the condition occurred; a time, date, or day of the week at which the condition occurred; and a specified application or user that submitted the query that was being executed when the condition occurred; or any other appropriate execution criteria. Each of the exit programs 160 may have the same execution criteria, or some or all of the exit programs 160 may have different execution criteria.

If the determination at block 912 is true, then the execution criteria for the current exit program 160 is met, so control continues to block 915 where the query governor 168 sets the current exit program to be an uninvoked exit program that is registered for the met condition and met execution criteria and invokes the current exit program. The query governor 168 may provide to the current exit program 160, e.g., as parameters, the query, the access plan 154, the predicted cost of the access plan 154, the predicted query runtime, the predicted internal storage needed, the predicted runtime threshold, the predicted storage threshold, an identifier of the database 162, information about the system, job, or process that is to execute the access plan 154, information about the application 136 that requested the query, any other appropriate information, or any portion, multiple, or combination thereof. The current exit program 160 analyzes the provided information and returns a current return code, which the query governor 168 receives. The current return code is a request or recommendation of an action to be taken regarding continuing/canceling execution of the access plan and/or logging/not logging data. If the current exit program 160 does not exit, the query governor 168 sets the current return code to indicate that the current exit program 160 does not exist.

Control then continues to block 920 where the query governor 168 determines whether the current return code is the return code with the highest priority 290 in the return code data 172. If the determination at block 920 is true, then the current return code has the highest priority 290, so control continues to block 925 where the query governor 168 sets the saved return code to be the current return code. Control then continues to block 999 where the logic of FIG. 9 returns the saved return code, which is the return code returned by the current exit program 160 and is also the highest priority return code. In this way, once the highest priority return code is received from an exit program 160, no more exit programs are invoked for the condition and execution criteria, even if they exist.

If the determination at block 920 is false, then the current return code is not the highest priority return code, so control continues to block 930 where the query governor 168 determines if the current return code has a higher priority 290 than the saved return code (which is the highest priority return code returned so far). If the determination at bock 930 is true, then the current return code does have a higher priority 290 than the saved return code, so control continues to block 935 where the query governor 168 sets the saved return code to be the current return code. Control then returns to block 910, as previously described above.

If the determination at block 930 is false, then the current return code does not have a higher priority 290 than the saved return code, so the query governor 168 sets the current exit program to be the next registered exit program for the met condition, and control returns to block 910, as previously described above.

If the determination at block 912 is false, then the execution criteria for the current exit program 160 is not met, so the query governor 168 sets the current exit program to be the next registered exit program for the met condition, and control returns to block 910, as previously described above.

If the determination at block 910 is false, then all of the registered exit programs have been processed by the loop that starts at block 910, so control continues to block 999 where the logic of FIG. 9 returns the return code, which is the highest priority return code that was received from the exit programs that were invoked by the logic of FIG. 9.

Although the logic of FIG. 9 has been illustrated using the priority 290 from the return code data 172, in another embodiment, the exit program 160 may return a priority for its return code, which the query governor 168 uses.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
calculating a cost of an access plan for a query;
if the cost meets a condition, determining whether an exit program is registered for the condition; and
if the exit program is registered for the condition, invoking the exit program, receiving a return code from the exit program, logging data for the access plan if the logging is requested by the return code, continuing execution of the access plan if the continuing is requested by the return code, and canceling the execution of the access plan if the canceling is requested by the return code.

2. The method of claim 1, wherein the calculating further comprises:
predicting the cost based on the access plan prior to the execution.

3. The method of claim 2, wherein the predicting further comprises:
predicting a predicted time for the execution; and
predicting a predicted amount of storage needed for the execution, wherein the cost comprises the predicted time and the predicted amount.

4. The method of claim 1, wherein the calculating further comprises:
calculating the cost based on partial execution of the access plan.

5. The method of claim 4, wherein the calculating further comprises:
calculating an actual time used by the partial execution of the access plan; and
calculating an actual amount of storage used by the partial execution of the access plan, wherein the cost comprises the actual time and the actual amount.

6. The method of claim 1, further comprising:
sending an inquiry message to an application that requested the query if the inquiry message is requested by the return code;
receiving a response to the inquiry message; and
logging the data if the logging is requested by the response, continuing execution of the access plan if the continuing is requested by the response, and canceling the execution of the access plan if the canceling is requested by the response.

7. The method of claim 1, further comprising:
sending an inquiry message to an application that requested the query if the exit program is not registered for the condition;
receiving a response to the inquiry message; and
logging the data if the logging is requested by the response, continuing execution of the access plan if the continuing is requested by the response, and canceling the execution of the access plan if the canceling is requested by the response.

8. The method of claim 6, further comprising:
logging the data if the logging is not requested by the response and an override parameter requests the logging.

9. The method of claim 1, further comprising:
logging the data if the logging is not requested by the return code and an override parameter requests the logging.

10. A signal-bearing medium encoded with instructions, wherein the instructions when executed comprise:
calculating a cost of an access plan for a query;
if the cost meets a condition, determining whether an exit program is registered for the condition; and
if the exit program is registered for the condition, invoking the exit program, receiving a return code from the exit program, logging data for the access plan if the logging is requested by the return code, continuing execution of the access plan if the continuing is requested by the return code, canceling the execution of the access plan if the canceling is requested by the return code, and logging the data if the logging is not requested by the return code and an override parameter requests the logging.

11. The signal-bearing medium of claim 10, wherein the calculating further comprises:
predicting the cost based on the access plan prior to the execution, wherein the predicting further comprises predicting a predicted time for the execution and predicting a predicted amount of storage needed for the execution, wherein the cost comprises the predicted time and the predicted amount.

12. The signal-bearing medium of claim 10, wherein the calculating further comprises:
calculating an actual time used by partial execution of the access plan; and
calculating an actual amount of storage used by the partial execution of the access plan, wherein the cost comprises the actual time and the actual amount.

13. The signal-bearing medium of claim 10, further comprising:
sending an inquiry message to an application that requested the query if the inquiry message is requested by the return code;
receiving a response to the inquiry message; and
logging the data if the logging is requested by the response, continuing execution of the access plan if the continuing is requested by the response, canceling the execution of the access plan if the canceling is requested by the response, and logging the data if the logging is not requested by the response and an override parameter requests the logging.

14. A method for configuring a computer, wherein the method comprises:
configuring the computer to calculate a cost of an access plan for a query;
configuring the computer to determine whether a plurality of exit programs are registered for a condition if the cost meets the condition; and
configuring the computer to, if the plurality of exit programs are registered for the condition, invoke the plurality of exit programs, receive a plurality of return codes from the exit programs, determine the return code with a highest priority, log data for the access plan if the logging is requested by the return code with the highest priority, continue execution of the access plan if the continuing is requested by the return code with the highest priority, cancel the execution of the access plan if the canceling is requested by the return code with the highest priority, and log the data if the logging is not requested by the return code with the highest priority and an override parameter requests the logging.

15. The method of claim 14, wherein the configuring the computer to calculate further comprises:
configuring the computer to predict the cost based on the access plan prior to the execution, wherein the predicting further comprises predicting a predicted time for the execution, and predicting a predicted amount of storage needed for the execution, wherein the cost comprises the predicted time and the predicted amount.

16. The method of claim 14, wherein the configuring the computer to calculate further comprises:
configuring the computer to calculate an actual time used by partial execution of the access plan; and
configuring the computer to calculate an actual amount of storage used by the partial execution of the access plan, wherein the cost comprises the actual time and the actual amount.

17. The method of claim 14, further comprising:
configuring the computer to send an inquiry message to an application that requested the query if the inquiry message is requested by the return code with the highest priority;
configuring the computer to receive a response to the inquiry message; and
configuring the computer to log the data if the logging is requested by the response, to continue execution of the access plan if the continuing is requested by the response, to cancel the execution of the access plan if the canceling is requested by the response, and to log the data if the logging is not requested by the response and an override parameter requests the logging.

18. The method of claim 14, wherein the override parameter is scoped to a database to which the query is directed.

19. The method of claim 14, wherein the override parameter is scoped to a job that performs the execution.

20. The method of claim 14, wherein the override parameter is scoped to the computer.
